(19) United States
(12) Patent Application Publication
(10) Pub. No.: US 2021/0399431 A1
(43) Pub. Date: Dec. 23, 2021

(54) BASE STATION ANTENNA

(71) Applicant: CommScope Technologies LLC, Hickory, NC (US)

(72) Inventors: HAIYAN CHEN, Suzhou (CN); Pengfei Guo, Suzhou (CN)

(21) Appl. No.: 17/342,685

(22) Filed: Jun. 9, 2021

(30) Foreign Application Priority Data
Jun. 17, 2020 (CN) 202010552770.2

(51) Int. Cl. H01Q 17/00; H01Q 1/24

(52) U.S. Cl. CPC H01Q 17/00; H04W 88/08; H01Q 1/246

(57) ABSTRACT

A base station antenna may include a radiation element configured to operate in a predetermined frequency band; and an absorbing device arranged above the radiation element and configured to absorb electromagnetic radiation of the predetermined frequency band. The absorbing device may be made of a metamaterial.

### CROSS-REFERENCE TOR RELATED APPLICATION

The present application claims priority under 35 U.S.C. § 119 to Chinese Patent Application No. 202010552770.2, filed on Jun. 17, 2020, with the China National Intellectual Property Administration, and the entire contents of the above-identified application are incorporated by reference as if set forth herein.

### TECHNICAL FIELD

The present disclosure relates to base station antennas.

### BACKGROUND

Cellular communication systems are well known in the art. In a typical cellular communication system, a geographic region is divided into a series of regions called “cells”, and each cell is served by a base station. The base station may include a base station antenna, a baseband device, and a radio configured to provide bidirectional radio frequency (RF) communication with subscribers located throughout the cell. In many cases, a cell can be divided into multiple “sectors”, and different base station antennas provide coverage for each sector. Base station antennas are usually mounted on towers or other raised structures, and the radiation beam (“antenna beam”) generated by each antenna points outward to serve the corresponding sector.

### SUMMARY

Some embodiments of the present disclosure provide a base station antenna that includes a radiation element configured to operate in a predetermined frequency band; and an absorbing device arranged above the radiation element and configured to absorb an electromagnetic wave of the predetermined frequency band. The absorbing device may be made of a metamaterial.

According to some embodiments of the present disclosure, the wave absorbing device may include: a dielectric layer formed of a dielectric material and comprising a first surface and a second surface opposite to the first surface; a ground layer on the second surface of the dielectric layer; and a pattern layer on the first surface of the dielectric layer, the pattern layer is formed of a conductive material and includes an array of pattern units of a predetermined shape.

According to some embodiments of the present disclosure, the ground layer may be electrically connected to each of the plurality of pattern units.

According to some embodiments of the present disclosure, the predetermined shape includes one of a rectangle, a circle, a triangle, a hexagon or a ring.

According to some embodiments of the present disclosure, the ground layer may be electrically connected to each of the plurality of pattern units by conductive through holes.

According to some embodiments of the present disclosure, the absorbing device may include: a dielectric layer formed of a dielectric material; and a pattern layer on a surface of the dielectric layer. The pattern layer may be formed of a conductive material and includes an array of pattern units of a predetermined shape.

According to some embodiments of the present disclosure, the pattern unit may include a capacitive structure, and an inductive structure in series connection with the capacitive structure. The capacitive structure may be a sheet structure and the inductive structure may be a line structure. The inductive structure in each pattern unit may be electrically connected with the inductive structure in the adjacent pattern unit. The capacitive structure may be approximately square. Each side or corner of the square may have a concave region, and the inductive structure may include four line structures corresponding to the concave regions, with each of the line structures extending outwards from the corresponding concave region and electrically connected with the line structure in the adjacent pattern unit. Each line structure may be configured to include one or more parts parallel to the corresponding side of the square. The predetermined frequency band may be related to an area of the sheet structure, and a length and a width of the line structure.

According to some embodiments of the present disclosure, the predetermined frequency band may be related to a spacing between adjacent pattern units, a thickness of the dielectric layer and a dielectric constant of the dielectric material.

According to some embodiments of the present disclosure, the predetermined frequency band may be related to a size of the conductive through hole.

According to some embodiments of the present disclosure, the predetermined frequency band may be in a range between 5.15 GHz-5.25 GHz.

Some embodiments of the present disclosure provide a base station antenna that includes a radiation element configured to operate in a first predetermined frequency band and a second predetermined frequency band; and an absorbing device arranged above the radiation element and configured to absorb electromagnetic waves in the first and second frequency bands. The absorbing device may include: a first dielectric layer, formed of a first dielectric material and including a first surface and a second surface opposite the first surface; a second dielectric layer, formed of a second dielectric material and including a third surface and a fourth surface opposite to the third surface; a common ground layer between the second surface of the first dielectric layer and the fourth surface of the second dielectric layer; a first pattern layer on the first surface of the first dielectric layer, the first pattern layer formed of a conductive material and including an array of a plurality of first pattern units of a predetermined shape; and a second pattern layer on the third surface of the second dielectric layer, the second pattern layer formed of a conductive material and including an array of a plurality of second pattern units of a predetermined shape.

According to some embodiments of the present disclosure, the common ground layer may be electrically connected to the first pattern layer and the second pattern layer.

According to some embodiments of the present disclosure, the predetermined shape includes one of a rectangle, a circle, a triangle, a hexagon, or a ring.

According to some embodiments of the present disclosure, the common ground layer may be electrically connected to the first pattern layer through first conductive through holes, and the common ground layer may be electrically connected to the second pattern layer through second conductive through holes.

According to some embodiments of the present disclosure, the first predetermined frequency band may be related to a spacing between adjacent first pattern units, a thickness of the first dielectric layer, a dielectric constant of the first dielectric material, and a size of the first pattern unit.

According to some embodiments of the present disclosure, the second predetermined frequency band may be related to a spacing between adjacent second pattern units, a thickness of the second dielectric layer, a dielectric constant of the second dielectric material, and a size of the second pattern unit.

According to some embodiments of the present disclosure, the first frequency band may be related to a size of the first conductive through holes, and the second frequency band is related to the size of the second conductive through holes.

Some embodiments of the present disclosure provide a base station antenna that may include a radiation element configured to operate in a first frequency band and a second frequency band; and an absorbing device arranged above the radiation element and configured to absorb electromagnetic waves in the first and second frequency bands. The absorbing device may include a dielectric layer formed of a dielectric material and including a first surface and a second surface opposite to the first surface; a first pattern layer on the first surface of the dielectric layer, the first pattern layer formed of a conductive material and including an array of a plurality of first pattern units of a predetermined shape; and a second pattern layer on the second surface of the dielectric layer, the second pattern layer formed of a conductive material and including an array of a plurality of second pattern units of a predetermined shape.

According to some embodiments of the present disclosure, the first pattern unit may include a first capacitive structure and a first inductive structure in series connection with the first capacitive structure, and the second pattern unit may include a second capacitive structure and a second inductive structure in series connection with the second capacitive structure. The first capacitive structure and the second capacitive structure may be sheet structures, and the first inductive structure and the second inductive structure may be line structures. The first inductive structure in each first pattern unit may be electrically connected with the inductive structure in the adjacent first pattern unit, and the second inductive structure in each second pattern unit may be electrically connected with the inductive structure in the adjacent second pattern unit. The first capacitive structure and the second capacitive structure may be substantially square. Each side or corner of the square may have a concave region, the first inductive structure and the second inductive structure may include four line structures corresponding to the concave regions, and each line structure may extend outwards from the corresponding concave region and may be electrically connected with the line structure in the adjacent pattern unit. Each line structure may be configured to include one or more parts parallel to a corresponding side of the square. The first frequency band may be related to an area of the sheet structure and a length and width of the line structure in the first pattern unit, and the second frequency band may be related to an area of the sheet structure and a length and width of the line structure in the second pattern unit.

According to some embodiments of the present disclosure, the first frequency band may be related to a size of the first pattern unit, a spacing between adjacent first pattern units, a thickness of the dielectric layer, and a dielectric constant of the dielectric material.

According to some embodiments of the present disclosure, the second frequency band may be related to a size of the second pattern unit, a spacing between adjacent second pattern units, a thickness of the dielectric layer, and a dielectric constant of the dielectric material.

Some embodiments of the present disclosure provide a base station that includes a base station antenna as disclosed herein.

Other features and advantages of the present disclosure will become clearer by the following detailed description of exemplary embodiments of the present disclosure with reference to the accompanying drawings.

### BRIEF DESCRIPTION OF THE DRAWINGS

The drawings form part of the specification and illustrate example embodiments of the disclosure, and are used together with the specification to explain the principles of the disclosure.

With reference to the accompanying drawings, the present disclosure can be more clearly understood in accordance with the following detailed description, wherein

FIG. 1 is a schematic diagram of a base station antenna.

FIG. 2 is a sectional view of an absorbing device according to an embodiment of the present disclosure.

FIG. 3 is a schematic diagram of a pattern layer of an absorbing device according to an embodiment of the present disclosure.

FIGS. 4 and 5 are graphs showing the side lobe level (SLL) for of antenna beams at two different polarizations in the frequency band of 5.15 GHz-5.25 GHz for a base station antenna that includes an absorbing device according to the embodiment of the present disclosure.

FIG. 6 is a schematic diagram of a pattern layer of an absorbing device according to a further embodiment of the present disclosure.

FIG. 7 is a schematic diagram of a pattern layer of an absorbing device according to a further embodiment of the present disclosure.

FIGS. 8A-8C are diagrams that illustrate a method of manufacturing an absorbing device according to an embodiment of the present disclosure.

FIG. 9 is a schematic diagram of an absorbing device according to an embodiment of the present disclosure.

FIG. 10 is a sectional view of an absorbing device according to an embodiment of the present disclosure.

FIG. 11 is a schematic diagram of a pattern layer of an absorbing device according to an embodiment of the present disclosure.

FIG. 12 is a schematic diagram of a pattern unit in a pattern layer of an absorbing device according to an embodiment of the present disclosure.

FIG. 13 is a schematic diagram of a pattern layer of an absorbing device according to an embodiment of the present disclosure.

FIG. 14 is a schematic diagram of a pattern unit in a pattern layer of an absorbing device according to an embodiment of the present disclosure.

FIG. 15 is a schematic diagram of a pattern layer of an absorbing device according to an embodiment of the present disclosure.

FIG. 16 is a schematic diagram of a pattern unit in a pattern layer of an absorbing device according to an embodiment of the present disclosure.

FIG. 17 is a schematic diagram of a pattern layer of an absorbing device according to an embodiment of the present disclosure.

FIG. 18 is a schematic diagram of a pattern unit in a pattern layer of an absorbing device according to an embodiment of the present disclosure.

FIG. 19 is a sectional view of an absorbing device according to an embodiment of the present disclosure.

Note that, in the embodiments described below, the same reference numbers are commonly used between different drawings to indicate the same components or components having the similar function, and repeated description thereof is omitted. In some cases, similar reference numbers and letters are used to denote similar items, so once an item is defined in one drawing, there is no need to discuss it further in subsequent drawings.

For ease of understanding, the position, size, and range of each structure shown in the drawings and the like may not indicate the actual position, size, and range. Therefore, the present disclosure is not limited to the positions, sizes, ranges, etc. disclosed in the drawings and the like.

### DETAILED DESCRIPTION

Various exemplary embodiments of the present disclosure will be described in detail below with reference to the drawings. It should be noted that the relative arrangement of components and steps, numerical expressions, and numerical values set forth in these embodiments do not limit the scope of the present disclosure unless specifically stated otherwise.

The following description of at least one exemplary embodiment is merely illustrative, and in no way serves as any limitation to the present disclosure and its application or use. That is, the structures and methods herein are shown in an exemplary manner to illustrate different embodiments of the inventive concepts disclosed herein. However, those skilled in the art will understand that the shown structures and methods only illustrate exemplary ways of implementing the present disclosure, not exhaustively. In addition, the drawings are not necessarily drawn to scale, and some features may be exaggerated to show details of specific components.

Techniques, methods, and equipment known to those of ordinary skill in the related art may not be discussed in detail, but where appropriate, the techniques, methods, and equipment should be considered as part of the specification.

In all examples shown and discussed herein, any specific value should be interpreted as merely exemplary and not limiting. Therefore, other examples of the exemplary embodiment may have different values.

Base station antennas are usually mounted on elevated structures such as antenna towers and radiate electromagnetic radiation outwardly. In many cases, the radiation pattern may be designed to have a small downtilt (e.g., 1°-10°). The base station antenna will also radiate electromagnetic wave upwardly. In some jurisdictions, there are limitations on the amount of radiation that may be emitted above certain angles with respect to the horizon. These limitations may, for example, protect satellites from interference. For example, the United States Federal Communications Commission (FCC) stipulates that in the UN-II1 band (5.15 GHz-5.25 GHz), in an upward direction which has an angle with respect to the horizon that is greater than 30°, the effective isotropic radiated power (EIRP) must be less than 125 mW. Typically, the central or “main” beam of the radiation pattern of a base station antenna will have an elevation beamwidth of less than 60°, and hence the main beam will typically not emit radiation at angles of 30° or more above the horizon. However, the radiation pattern of a base station antenna also typically includes so-called side lobes which refer to secondary peaks in the radiation pattern on either “side” of the main beam. The maximum gain of a side lobe is often referred to as the “level” of the side lobe. In order to stay within limits on the amount of upwardly directed radiation it may be necessary to keep the side lobe level (SLL) of a base station antenna below a certain level. The SLL in this region is mainly caused by the diffraction of creeping waves. Creeping waves are usually generated by surface currents that may flow on the reflector plate of the base station antenna.

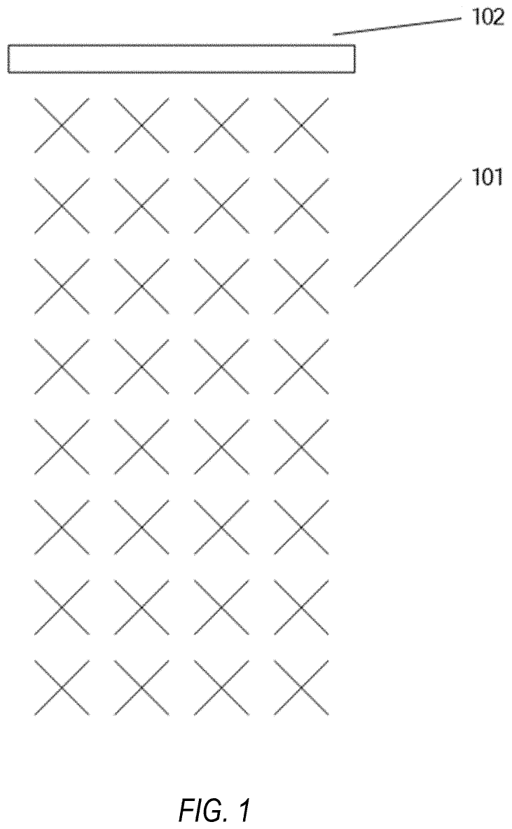

FIG. 1 is a schematic diagram of a base station antenna. As shown in FIG. 1, in order to limit upwardly directed radiation generated by creeping waves, an absorbing device 102 may be positioned above the radiation element array 101. The absorbing device 102 may absorb electromagnetic radiation that is scattered upwardly from the radiation element array 101 and/or that is generated by creeping waves flowing on the surface of a reflecting plate (not shown) of the base station antenna. The absorbing device 102 may be, for example, a plate-shaped component made of an absorbing material. However, the cost of the absorbing material is high, which increases the cost of the base station antenna.

In some embodiments according to the present disclosure, the absorbing device may be made of a metamaterial. The metamaterial is a man-made material with special properties, which can make electromagnetic waves change their common properties. The properties of the metamaterial come from its precise geometry and size.

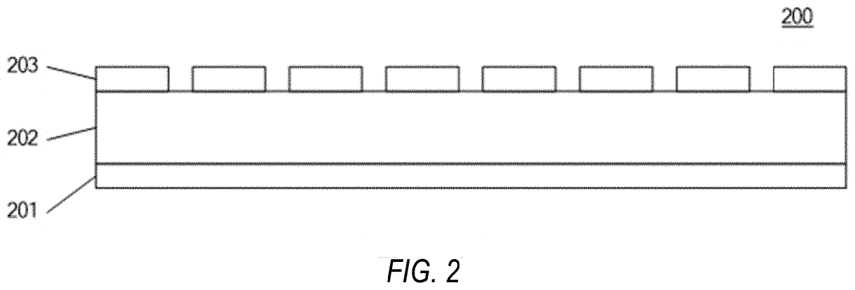

FIG. 2 is a sectional view of an absorbing device according to an embodiment of the present disclosure. As shown in FIG. 2, the absorbing device 200 includes a ground layer 201, a dielectric layer 202, and a pattern layer 203. In some embodiments, a printed circuit board may be used to implement all three layers of the absorbing device 200. The dielectric layer 202 is formed of a dielectric material, such as FR4. The ground layer 201 is on one surface (second surface) of the dielectric layer 202, and the ground layer 201 may be a metal layer, such as a copper layer, etc. The pattern layer 203 is on another surface (first surface) of the dielectric layer 202 that is opposite from the surface of the 202 that faces the ground layer 201. The pattern layer 203 is formed of a conductive material (such as metal, etc.) and includes an array of a plurality of patterns (i.e., pattern units) of a predetermined shape.

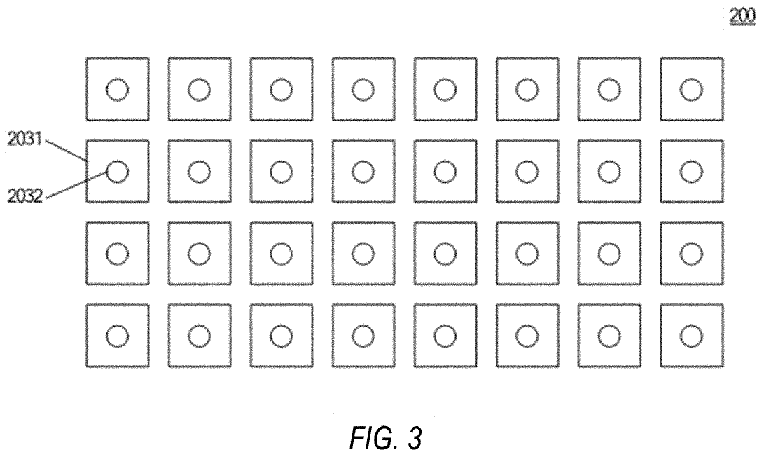

FIG. 3 is a schematic diagram of a pattern layer of an absorbing device according to some embodiments of the present disclosure. As shown in FIG. 3, the pattern layer 203 is composed of a plurality of square conductive regions 2031 that are arranged in an array. The center of each square conductive region 2031 has a conductive through hole 2032, so that the square conductive region 2031 is electrically connected to the grounding layer 201 through the conductive through hole 2032.

By properly setting the parameters of the absorbing device 200, the absorbing device 200 can absorb electromagnetic waves of a predetermined frequency band. These parameters may include, for example, the thickness of the dielectric layer 202, the dielectric constant of the dielectric material, the shape and size of each pattern 2031, the spacing between adjacent patterns, and the like.

For example, in some embodiments according to the present disclosure, if it is desired that the absorbing device 200 absorbs electromagnetic waves of 5.15 GHz-5.25 GHz frequency band, the thickness of the dielectric layer 202 can be set to 60 mil, the dielectric constant of the dielectric material FR4 can be 5, the side length of the square pattern 2031 can be 9.7 mm, the spacing between adjacent patterns 2031 can be 10.5 mm, and the diameter of the through hole can be 1 mm.

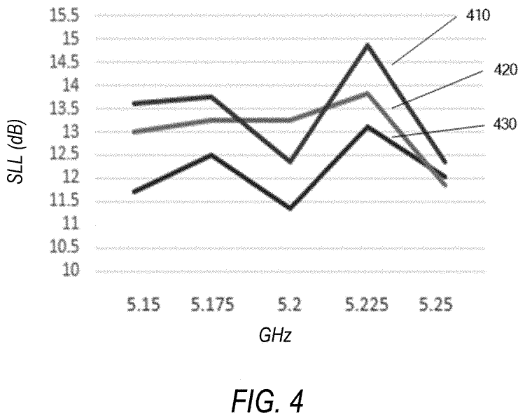

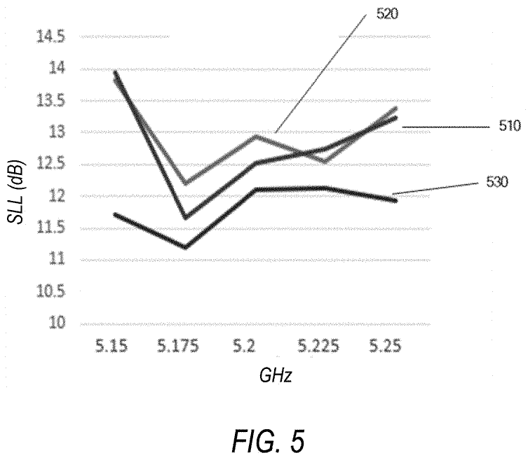

FIGS. 4 and 5 respectively shows curves 410 and 510 of SLL in the frequency band of 5.15 GHz-5.25 GHz for the positive polarization port P1 and the negative polarization port P2 of a base station antenna that includes the absorbing device of the above-described embodiment. In addition, FIG. 4 and FIG. 5 also show curves 420 and 520 that are measured in a base station antenna that includes an absorbing device made of a conventional absorbing material, and curves 430 and 530 where no absorbing device is provided in the base station antenna. It can be seen from FIGS. 4 and 5 that the SLL in the frequency band of 5.15 GHz-5.25 GHz frequency band can be decreased by using the absorbing device in the base station antenna (note that the SLL level is shown in FIGS. 4 and 5 as a negative decibel value, which represents the magnitude of the SLL below the peak of the radiation pattern).

It can be seen from FIG. 4 and FIG. 5 that the conventional absorbing device can be replaced by the absorbing device made of metamaterial according to the embodiment of the present disclosure, and the effect of absorbing electromagnetic wave of predetermined frequency band can also be realized. Therefore, the SLL of the electromagnetic wave radiated upward can be improved by the absorbing device arranged above the radiation element array.

In some embodiments, rather than the pattern shown in FIG. 3, the pattern layer may have a different pattern, with the understanding that the present disclosure is not limited to those explicitly shown here.

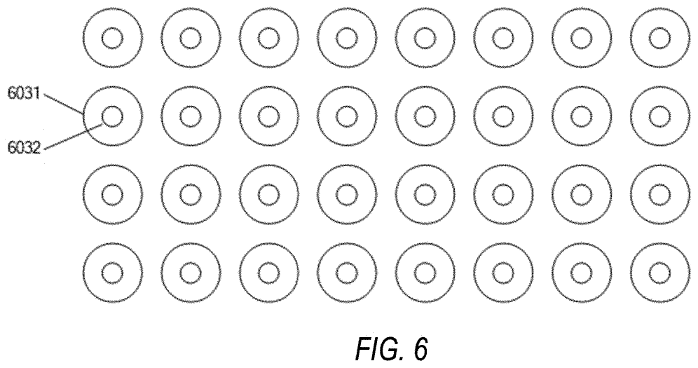

For example, FIG. 6 is a schematic diagram of a pattern layer of an absorbing device according to some embodiments of the present disclosure. As shown in FIG. 6, the pattern layer includes an array composed of a plurality of circular areas 6031, the center of each circular area 6031 is electrically connected to a ground layer on the other side of the dielectric layer through a conductive through hole 6032.

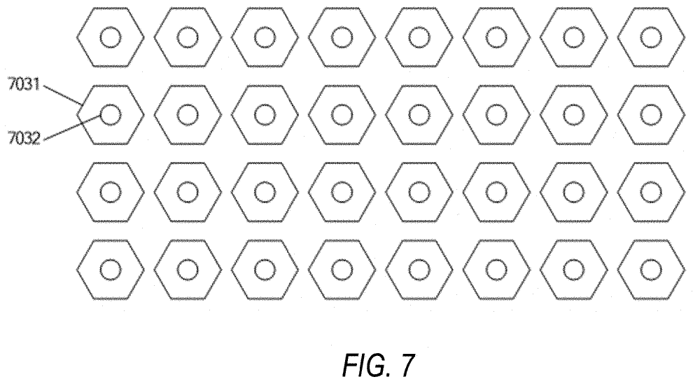

FIG. 7 is a schematic diagram of a pattern layer of an absorbing device according to some embodiments of the present disclosure. As shown in FIG. 7, the pattern layer includes an array composed of a plurality of hexagonal regions 7031, the center of each hexagonal region 7031 is electrically connected to a ground layer on the other side of the dielectric layer through a conductive through hole 7032.

It should be understood that some examples of patterns of pattern layers are given above, but the present disclosure is not limited to these. For example, a pattern layer can also contain an array of areas of other shapes, such as triangles, rectangles, rings, and so on.

Further, as described above, the parameters of the absorbing device according to some embodiments of the present disclosure depend on the frequency band of the electromagnetic wave to be absorbed. These parameters include, for example, the size and spacing of each area in the pattern layer, the diameters of the through holes, the thickness of the dielectric layer, the dielectric constant of the dielectric material, etc.

In addition, when the absorbing device according to the embodiment of the present disclosure is mounted in a base station antenna, the pattern layer can face the radiation element array in the base station antenna, or the ground layer can face the radiation element array in the base station antenna. Both arrangements can achieve the absorption of the electromagnetic radiation in the predetermined frequency band.

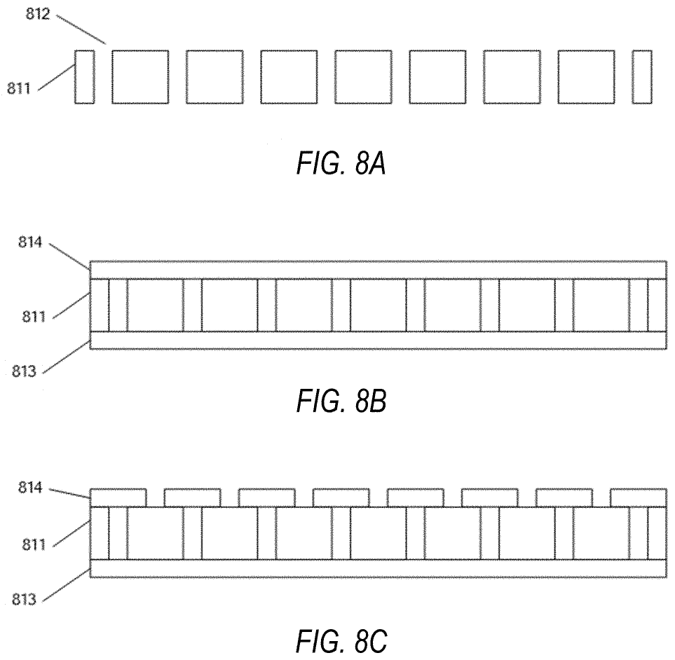

FIGS. 8A-8C illustrate a process for manufacturing a wave absorbing device according to some embodiments of the present disclosure. As shown in FIG. 8A, first, a substrate 811 which is made of a dielectric material is provided as a dielectric layer of the absorbing device, and through-holes 812 are formed at predetermined positions.

Then, as shown in FIG. 8B, a metal layer 813 and a metal layer 814 are respectively formed on both sides of the substrate 811. The metal layer 813 serves as the ground layer of the absorbing device. For example, the metal layer 813 and a metal layer 814 may be formed by deposition or electroplating. In addition, in the process of forming the metal layer 813 and the metal layer 814, a metal layer or a metal plug is also formed on the side wall or inside of the through holes 812, so that the metal layer 813 and the metal layer 814 are electrically connected to each other.

Finally, as shown in FIG. 8C, the metal layer 814 is patterned to form an array of patterns of a predetermined shape. Each of the patterned regions of a predetermined shape is electrically connected to the metal layer 813 (i.e. the ground layer) through the corresponding through hole 812.

It is to be understood that the method of manufacturing the absorbing device according to the embodiment of the present disclosure are not limited to the process shown in above FIGS. 8A-8C. Those skilled in the art may adopt any process and method, as long as the absorbing device according to the embodiment of the present disclosure can be obtained.

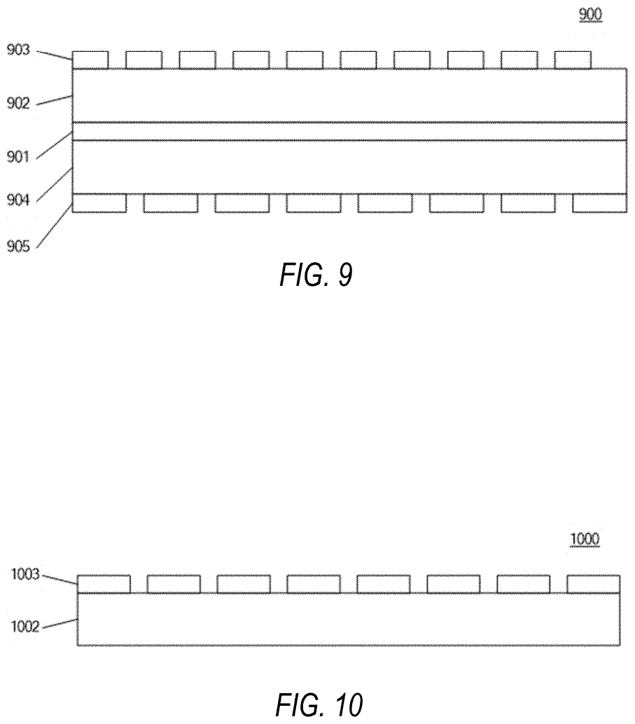

FIG. 9 is a schematic diagram of an absorbing device according to some embodiments of the present disclosure. As shown in FIG. 9, the absorbing device 900 includes a first pattern layer 905, a first dielectric layer 904, a common ground layer 901, a second dielectric layer 902, and a second pattern layer 903. The first dielectric layer 904 and the second dielectric layer 902 are both made of dielectric materials. The common ground layer 901 is a conductive layer, for example, a metal layer. Both the first pattern layer 905 and the second pattern layer 903 are formed of a conductive material (such as metal, etc.), and each includes an array composed of a plurality of patterns of a predetermined shape. In this embodiment, the array of patterns of the first pattern layer 905 and the array of patterns of the second pattern layer 903 may be different.

By designing the parameters of the absorbing device 900, the absorbing device 900 can absorb electromagnetic waves in a first predetermined frequency band (e.g., 5.15 GHz-5.25 GHz) and in a second predetermined frequency band (e.g., 3.1 GHz-4.2 GHz) different from the first frequency band. Therefore, the absorbing device 900 according to the present disclosure can absorb electromagnetic waves in two different frequency bands, and is suitable for base station antennas that use multiple frequency bands for communication.

For example, in some embodiments according to the present disclosure, the thickness of the first dielectric layer, the dielectric constant of the dielectric material of the first dielectric layer, the shape and size of the pattern in the first pattern layer, and the spacing between adjacent patterns, etc. in the absorbing device 900 may be designed according to the first predetermined frequency band. The thickness of the second dielectric layer, the dielectric constant of the dielectric material of the second dielectric layer, the shape and size of the pattern in the second pattern layer and the spacing between adjacent patterns in the absorbing device 900 can be designed according to the second predetermined frequency band. In this way, the absorbing device 900 can absorb electromagnetic waves of two different frequency bands.

In addition, in some embodiments according to the present disclosure, each pattern region in the first pattern layer and the second pattern layer may be electrically connected to the common ground layer through respective through holes. Since the absorbing device 200 with through-holes has been described above with reference to FIGS. 3-8, the description will not be repeated here.

In addition, in some embodiments according to the present disclosure, two or more absorbing devices 200 shown in FIG. 2 can also be stacked, with each absorbing device 200 targeting different predetermined frequency bands. Such an arrangement may reach similar effect as that of FIG. 9.

FIG. 10 shows a sectional view of an absorbing device according to some embodiments of the present disclosure. As shown in FIG. 10, the absorbing device 1000 includes a dielectric layer 1002 and a conductive pattern layer 1003. Compared with the absorbing device 200 shown in FIG. 2, the absorbing device 1000 has no ground layer.

In some embodiments according to the present disclosure, each pattern (i.e., pattern unit) may include a capacitive structure and an inductive structure connected in series with the capacitive structure. In addition, the pattern units can be connected to one another through the inductive structure. For example, the inductive structure in each pattern unit may be electrically connected with the inductive structure in the adjacent pattern unit.

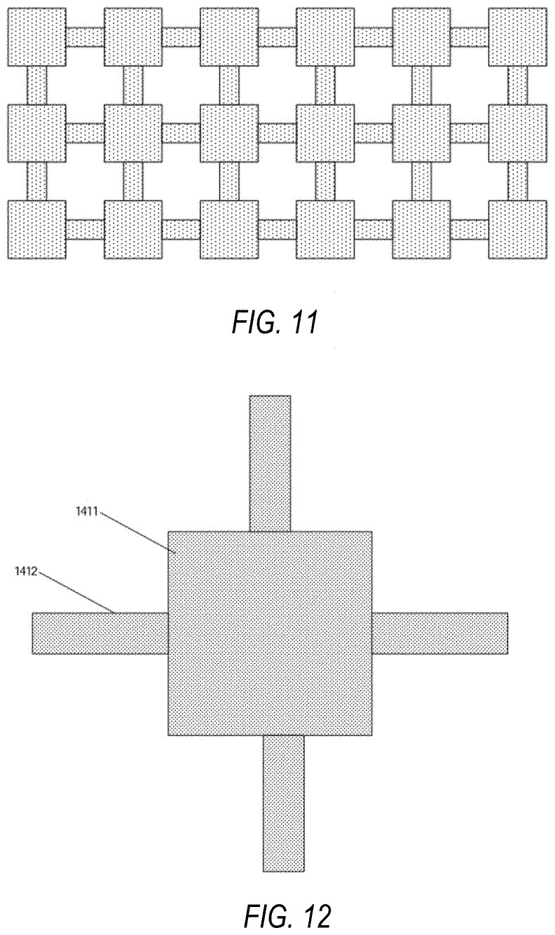

FIG. 11 is an example of a pattern layer of the absorbing device 1000 of FIG. 10. As shown in FIG. 11, the pattern layer is formed of conductive materials (such as copper, aluminum, gold, silver, etc.) and is composed of a plurality of pattern units arranged repeatedly along the horizontal and vertical directions.

FIG. 12 is a schematic diagram of one pattern unit in the pattern layer of FIG. 11. As can be seen from FIG. 12, the pattern unit is generally a square. The pattern unit includes a sheet structure 1211 and a plurality of line structures 1212, and the line structures 1212 extend outwardly from respective edges of the square sheet structure 1211, so as to be electrically connected with the line structures in respective adjacent pattern units. With the patterns shown in FIGS. 11 and 12, a circuit of capacitors and inductors in a series connection can be formed. The capacitance of the capacitor can be adjusted by adjusting the spacing between adjacent pattern units (for example, the spacing between adjacent sheet structures 1211) and the size of sheet structures 1211 (for example, area, length of a side, etc.). The inductance of the inductor can be adjusted by adjusting the size of the line structure 1212 (such as length, width, etc.). The predetermined frequency band of the electromagnetic wave that is absorbed by the absorbing device depends on the capacitance and inductance. Therefore, the predetermined frequency band corresponding to the absorbing device can be adjusted by adjusting the parameters of the pattern unit.

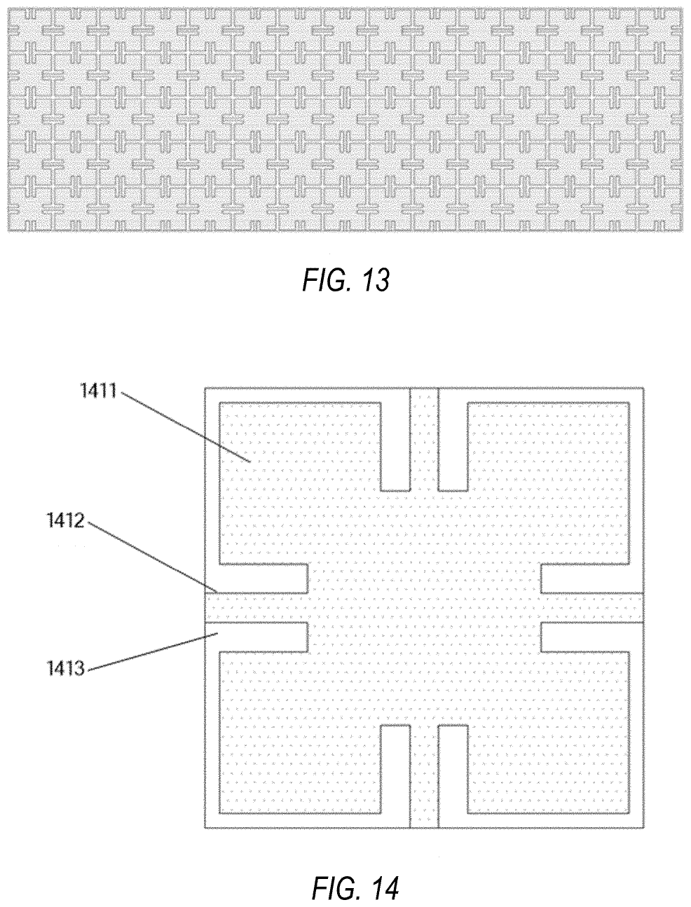

FIG. 13 is another example of a pattern layer of an absorbing device according to some embodiments of the present disclosure. FIG. 14 shows a schematic diagram of a pattern unit in the pattern layer of FIG. 13. As shown in FIG. 13 and FIG. 14, the pattern unit is substantially a square. The pattern unit includes a sheet structure 1411 and a line structure 1412, and the line structure 1412 extends outwards from a concave region 1413 on the side of the square sheet structure 1411, so as to be electrically connected to the line structure in the adjacent pattern unit. With the concave region 1413, the length of the line structure 1412 can be increased, thereby increasing the inductance value in the pattern unit.

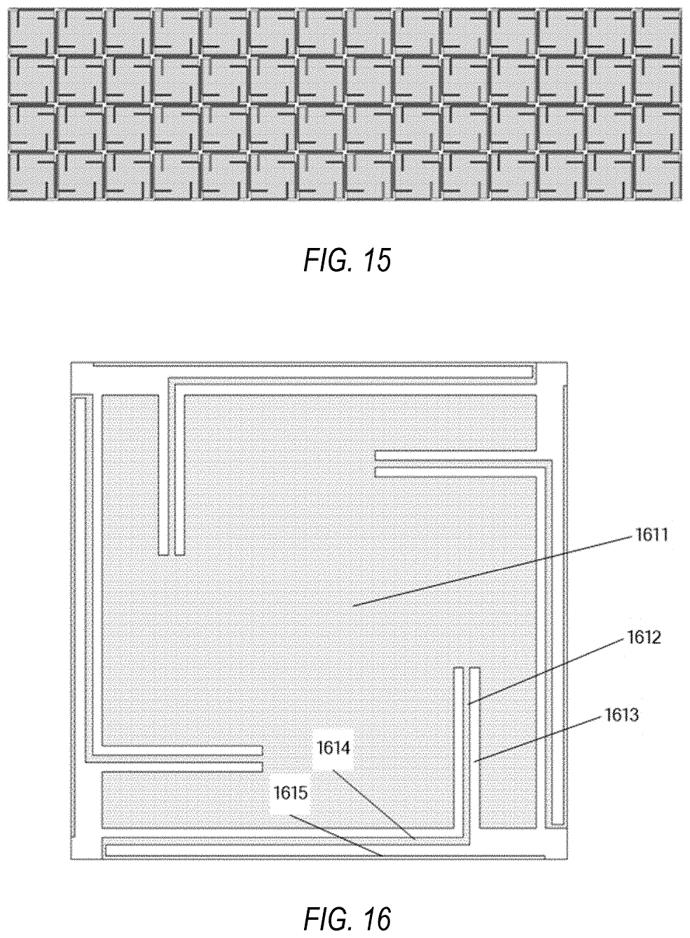

FIG. 15 shows an example of a pattern layer of an absorbing device according to some embodiments of the present disclosure. FIG. 16 is a schematic diagram of a pattern unit in the pattern layer of FIG. 15. As shown in FIG. 15 and FIG. 16, the pattern unit is substantially a square. The pattern unit includes a sheet structure 1611 and a line structure 1612, and the line structure 1612 extends outwards from a concave region 1613 on the side of the square sheet structure 1611, so as to be electrically connected to the line structure in the adjacent pattern unit. In addition, in order to increase the length of the line structure 1612, the line structure 1612 also has parts 1614 and 1615 parallel to the side of the square sheet structure 1611. With two parallel parts 1614 and 1615, the length of the line structure 1612 can be increased, thus increasing the inductance value in the pattern unit.

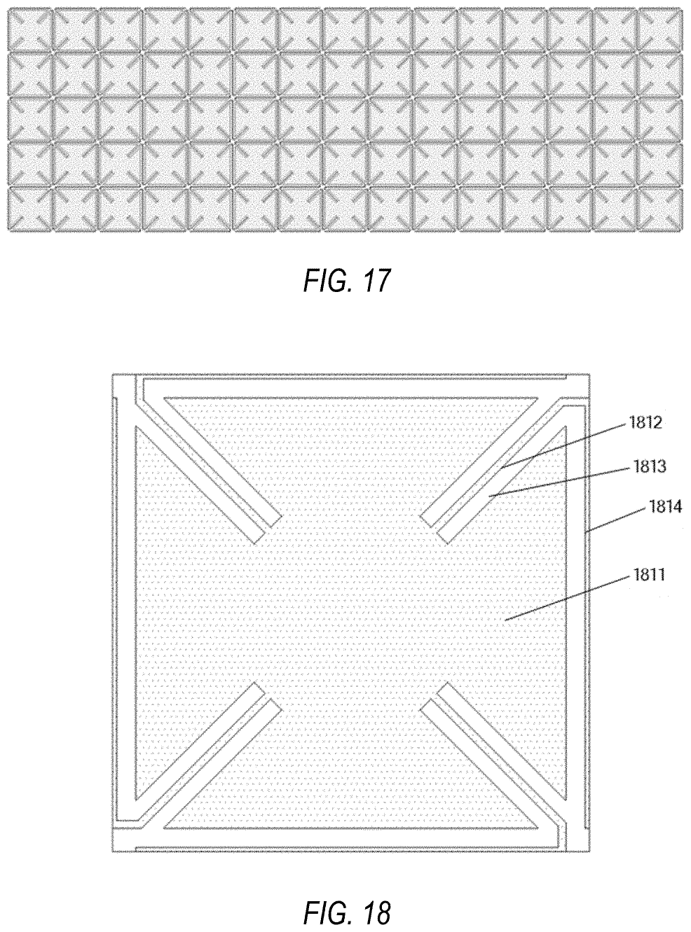

FIG. 17 shows an example of a pattern layer of an absorbing device according to some embodiments of the present disclosure. FIG. 18 is a schematic diagram of a pattern unit in the pattern layer of FIG. 17. As shown in FIG. 17 and FIG. 18, the pattern unit is substantially a square. The pattern unit includes a sheet structure 1811 and a line structure 1812, and the line structure 1812 extends outwards from a concave region 1813 on a side of the square sheet structure 1811, so as to be electrically connected with the line structure in the adjacent pattern unit. The concave regions 1813 are located at the corners of the square. In this way, the line structure 1812 will extend along the diagonal direction of the square, which is beneficial to increase the length of the line structure 1812. In addition, in order to increase the length of the line structure 1812, the line structure 1812 also has a part 1814 parallel to the side of the square. With the parallel part 1814, the length of the line structure 1812 can be increased, thereby increasing the inductance value in the pattern unit.

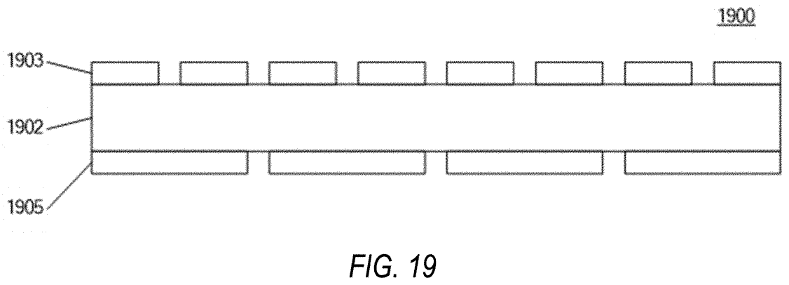

FIG. 19 is a sectional view of an absorbing device 1900 according to some embodiments of the present disclosure. As shown in FIG. 19, the absorbing device 1900 includes a dielectric layer 1902, a first pattern layer 1903 and a second pattern layer 1905. The first pattern layer 1903 is located on one surface of the dielectric layer 1902, and the second pattern layer 1905 is located on the other surface of the dielectric layer 1902. Similar to the embodiments according to the present disclosure shown in FIGS. 11-18, both the first pattern layer 1903 and the second pattern layer 1905 are made of conductive materials. The first pattern layer 1903 includes an array composed of a plurality of first pattern units of a predetermined shape, and the second pattern layer 1905 includes an array composed of a plurality of second pattern units of a predetermined shape. The first pattern unit and the second pattern unit may be the same or different. In the case where the first pattern unit and the second pattern unit are different, the absorbing device 1900 can absorb electromagnetic waves in two different frequency bands (the first and second frequency bands). The first frequency band can be related to the size of the first pattern units, the spacing between the adjacent first pattern units, the thickness of the dielectric layer 1902, and the dielectric constant of the dielectric material, while the second frequency band can be related to the size of the second pattern units, the spacing between the adjacent second pattern units, the thickness of the dielectric layer 1902, and the dielectric constant of the dielectric material. For example, the first frequency band may be related to the area of the sheet structure and the length and width of the line structure in the first pattern unit, and the second frequency band may be related to the area of the sheet structure and the length and width of the line structure in the second pattern unit. The first pattern unit and the second pattern unit may be similar to the pattern units described above with reference to FIG. 12, FIG. 14, FIG. 16 and FIG. 18, and will not be repeated here.

Schematic examples of pattern layers and pattern units according to some embodiments of the present disclosure are given above. However, it should be understood that the present disclosure is not limited to this, for example, the pattern unit may be of other shapes, such as rectangle, circle, polygon, even irregular shape, etc., which is not limited by the present disclosure.

It should be understood that in the present disclosure, if two frequency bands contain the same frequency range (i.e. the lowest frequency and the highest frequency are both the same), it is deemed that the two frequency bands are the same. Otherwise, the two frequency bands are considered different. For example, two different frequency bands can have a part of frequency overlap (that is, a part of frequency belongs to both the first and second frequency bands), or can be completely separated (that is, there is no common frequency).

According to some embodiments of the present disclosure, various technical solutions may be included, including those discussed below.

According to some technical solutions, a base station antenna may include: a radiation element configured to operate in a predetermined frequency band; and an absorbing device arranged above the radiation element and configured to absorb an electromagnetic wave of the predetermined frequency band. The absorbing device may be made of a metamaterial.

In some technical solutions, the absorbing device of the base station antenna comprises a dielectric layer formed of a dielectric material and comprising a first surface and a second surface opposite to the first surface; a ground layer on the second surface of the dielectric layer; and a pattern layer on the first surface of the dielectric layer, the pattern layer is formed of a conductive material and includes an array of pattern units of a predetermined shape. In some technical solutions, the ground layer is electrically connected to each of the plurality of pattern units. In some technical solutions, the predetermined shape includes a rectangle, a circle, a triangle, a hexagon and/or a ring. In some technical solutions, the ground layer is electrically connected to each of the plurality of pattern units by conductive through holes.

In some technical solutions, the absorbing device of the base station antenna a dielectric layer formed of a dielectric material; and a pattern layer on a surface of the dielectric layer, wherein the pattern layer is formed of a conductive material and includes an array of pattern units of a predetermined shape. In some technical solutions, the pattern unit comprises a capacitive structure; and an inductive structure in series connection with the capacitive structure. In some technical solutions, capacitive structure is a sheet structure and the inductive structure is a line structure. In some technical solutions, the inductive structure in each pattern unit is electrically connected with the inductive structure in the adjacent pattern unit. In some technical solutions, the capacitive structure is approximately square. In some technical solutions, each side or corner of the square has a concave region, and the inductive structure includes four line structures corresponding to the concave regions, each of the line structures extends outwards from the corresponding concave region and is electrically connected with the line structure in the adjacent pattern unit. In some technical solutions, each line structure is configured to include one or more parts parallel to the corresponding side of the square.

In some technical solutions, the predetermined frequency band is related to a spacing between adjacent pattern units, a thickness of the dielectric layer and a dielectric constant of the dielectric material.

In some technical solutions, the predetermined frequency band is related to a size of the conductive through hole.

In some technical solutions, the predetermined frequency band is related to an area of the sheet structure, a length and a width of the line structure.

In some technical solutions, the predetermined frequency band is 5.15 GHz-5.25 GHz.

According to some technical solutions, a base station antenna may include a radiation element configured to operate in a first predetermined frequency band and a second predetermined frequency band; and an absorbing device arranged above the radiation element and configured to absorb electromagnetic waves in the first and second frequency bands. The absorbing device may include a first dielectric layer, formed of a first dielectric material and comprising a first surface and a second surface opposite the first surface; a second dielectric layer, formed of a second dielectric material and comprises a third surface and a fourth surface opposite to the third surface; a common ground layer between the second surface of the first dielectric layer and the fourth surface of the second dielectric layer; a first pattern layer on the first surface of the first dielectric layer, wherein the first pattern layer is formed of a conductive material and includes an array of a plurality of first pattern units of a predetermined shape; a second pattern layer on the third surface of the second dielectric layer, wherein the second pattern layer is formed of a conductive material and includes an array of a plurality of second pattern units of a predetermined shape.

In some technical solutions, the common ground layer is electrically connected to the first pattern layer and the second pattern layer. In some technical solutions, the predetermined shape includes a rectangle, a circle, a triangle, a hexagon and/or a ring.

In some technical solutions, the common ground layer is electrically connected to the first pattern layer through first conductive through holes, and the common ground layer is electrically connected to the second pattern layer through second conductive through holes.

In some technical solutions, the first predetermined frequency band is related to a spacing between adjacent first pattern units, a thickness of the first dielectric layer, a dielectric constant of the first dielectric material, and a size of the first pattern unit.

In some technical solutions, the second predetermined frequency band is related to a spacing between adjacent second pattern units, a thickness of the second dielectric layer, a dielectric constant of the second dielectric material, and a size of the second pattern unit.

In some technical solutions, the first frequency band is related to a size of the first conductive through holes, and the second frequency band is related to the size of the second conductive through holes.

According to some technical solutions, a base station antenna may include a radiation element configured to operate in a first frequency band and a second frequency band; and an absorbing device arranged above the radiation element and configured to absorb electromagnetic waves in the first and second frequency bands. The absorbing device may include a dielectric layer formed of a dielectric material and comprising a first surface and a second surface opposite to the first surface; a first pattern layer on the first surface of the dielectric layer, wherein the first pattern layer is formed of a conductive material and includes an array of a plurality of first pattern units of a predetermined shape; and a second pattern layer on the second surface of the dielectric layer, wherein the second pattern layer is formed of a conductive material and includes an array of a plurality of second pattern units of a predetermined shape.

In some technical solutions, the first pattern unit comprises a first capacitive structure; and a first inductive structure in series connection with the first capacitive structure, while the second pattern unit includes a second capacitive structure; and a second inductive structure in series connection with the second capacitive structure. In some technical solutions, the first capacitive structure and the second capacitive structure are sheet structures, and the first inductive structure and the second inductive structure are line structures. In some technical solutions, the first inductive structure in each first pattern unit is electrically connected with the inductive structure in the adjacent first pattern unit, and the second inductive structure in each second pattern unit is electrically connected with the inductive structure in the adjacent second pattern unit. In some technical solutions, the first capacitive structure and the second capacitive structure are substantially square. In some technical solutions, each side or corner of the square has a concave region, the first inductive structure and the second inductive structure include four line structures corresponding to the concave regions, each line structure extends outwards from the corresponding concave region and is electrically connected with the line structure in the adjacent pattern unit. In some technical solutions, each line structure is configured to include one or more parts parallel to a corresponding side of the square.

In some technical solutions, the first frequency band is related to a size of the first pattern unit, a spacing between adjacent first pattern units, a thickness of the dielectric layer, and a dielectric constant of the dielectric material.

In some technical solutions, wherein the second frequency band is related to a size of the second pattern unit, a spacing between adjacent second pattern units, a thickness of the dielectric layer, and a dielectric constant of the dielectric material.

In some technical solutions, wherein the first frequency band is related to an area of the sheet structure and a length and width of the line structure in the first pattern unit, and the second frequency band is related to an area of the sheet structure and a length and width of the line structure in the second pattern unit.

According to some technical solutions, a base station may include any of the base station antennas discussed above.

The terms “before”, “after”, “top”, “bottom”, “above”, “below”, etc. in the specification and claims, if present, are for descriptive purpose and not necessarily used to describe an unchanged relative position. It will be understood that the terms are interchangeable in appropriate situations. The embodiments of the present disclosure described herein are, for example, capable of operating in orientation other than those shown or described herein.

As used in the present disclosure, the term “exemplary” means “serving as an example, instance, or illustration” rather than as a “model” to be precisely copied. Any embodiments exemplarily described herein are not necessarily to be construed as preferred or advantageous over other embodiments. Furthermore, the present disclosure is not limited by any of the stated or implied theory presented in the above technical field, the background, the summary or the detailed description of the embodiments.

As used herein, the term “substantially” is intended to include any minor variation resulting from a design or manufacturing defect, a device or component tolerance, environmental influence, and/or other factors. The term “substantially” also allows for deviation from perfect or ideal situations caused by parasitic effects, noise, and other practical considerations that may exist in actual implementations.

In addition, the foregoing description may refer to elements or nodes or features that are “connected” or “coupled” together. As used herein, “connect” means that an element/node/feature is directly connected electrically, mechanically, logically, or otherwise to (or directly communicate with) another element/node/feature, unless otherwise explicitly stated. Similarly, “couple” means that an element/node/feature may be mechanically, electrically, logically, or otherwise linked to another element/node/feature in a direct or indirect manner, unless explicitly stated otherwise to allow interaction, even if these two features may not be directly connected. That is, “couple” is intended to include both direct and indirect connection of elements or other features, and includes a connection with one or more intermediate elements.

In addition, the terms “first”, “second”, and the like may also be used herein for the purpose of reference only, and thus are not intended to be limiting. For example, the terms “first”, “second”, and other such numerical terms referring to the structure or element do not imply the sequence or order, unless specifically pointed out in the context.

It is also to be understood that the terms “comprise/include” herein means that the described features, steps, operations, units and/or components exist, but the existence or adding of one or more other features, steps, operations, units and/or components and/or combinations thereof are not excluded.

Those skilled in the art will appreciate that the boundaries between the above operations are merely illustrative. Multiple operations may be combined into a single operation, a single operation may be distributed among additional operations, and operations may be performed at least partially overlapping in time. Moreover, alternative embodiments may include multiple instances of a particular operation, and the operational sequence may be varied in other various embodiments. However, other modifications, changes, and substitutions are equally possible. Accordingly, the specification and drawings are to be regarded as illustrative rather than limiting.

While some specific embodiments of the present disclosure have been described in detail by way of example, a skilled person should be understood that the above examples are for illustrative purpose and have no intention to limit the scope of the present disclosure. The embodiments disclosed in the present disclosure may be combined in any manner without departing from the spirit and scope of the present disclosure. It will be understood by a person skilled in the art that various modifications may be made to the embodiments without departing from the scope and spirit of the present disclosure. The scope of the present disclosure is defined by the appended claims.

1. A base station antenna comprising:
a radiating element configured to operate in a predetermined frequency band; and
an absorbing device arranged above the radiation element and configured to absorb electromagnetic radiation within at least a portion of the predetermined frequency band,
wherein the absorbing device is made of a metamaterial.

2. The base station antenna of claim 1, wherein the absorbing device comprises:
a dielectric layer formed of a dielectric material and comprising a first surface and a second surface opposite the first surface;
a ground layer on the second surface of the dielectric layer; and
a pattern layer on the first surface of the dielectric layer, the pattern layer formed of a conductive material and includes an array of pattern units of a predetermined shape.

3. The base station antenna of claim 2, wherein the ground layer is electrically connected to at least some of the array of pattern units.

4-6. (canceled)

7. The base station antenna of claim 1, wherein the absorbing device comprises:
a dielectric layer formed of a dielectric material; and
a pattern layer on a surface of the dielectric layer, wherein the pattern layer is formed of a conductive material and includes an array of pattern units of a predetermined shape.

8. The base station antenna of claim 7, wherein each pattern unit of the array of pattern units comprises:
a capacitive structure; and
an inductive structure in series connection with the capacitive structure.

9. The base station antenna of claim 8, wherein the capacitive structure is a sheet structure and the inductive structure is a line structure.

10. The base station antenna of claim 8, wherein the inductive structure in each pattern unit is electrically connected with the inductive structure in an adjacent pattern unit.

11. The base station antenna of claim 9, wherein the capacitive structure is approximately square.

12-13. (canceled)

14. The base station antenna according to claim 9, wherein the predetermined frequency band is related to an area of the sheet structure, a length of the line structure and a width of the line structure.

15. The base station antenna according to claim 2, wherein the predetermined frequency band is related to a spacing between adjacent pattern units, a thickness of the dielectric layer and a dielectric constant of the dielectric material.

16. (canceled)

17. A base station antenna comprising:
a radiation element configured to operate in a first predetermined frequency band and a second predetermined frequency band; and
an absorbing device arranged above the radiation element and configured to absorb electromagnetic waves in the first and second predetermined frequency bands,
wherein the absorbing device includes:
a first dielectric layer comprising a first surface and a second surface opposite the first surface;
a second dielectric layer comprising a third surface and a fourth surface opposite the third surface;
a common ground layer between the second surface of the first dielectric layer and the fourth surface of the second dielectric layer;
a first pattern layer on the first surface of the first dielectric layer, wherein the first pattern layer is formed of a conductive material and includes an array of a plurality of first pattern units of a predetermined shape;
a second pattern layer on the third surface of the second dielectric layer, wherein the second pattern layer is formed of a conductive material and includes an array of a plurality of second pattern units of a predetermined shape.

18. The base station antenna of claim 17, wherein the common ground layer is electrically connected to the first pattern layer and the second pattern layer.

19. (canceled)

20. The base station antenna according to claim 17, wherein the common ground layer is electrically connected to the first pattern layer through first conductive through holes, and the common ground layer is electrically connected to the second pattern layer through second conductive through holes.

21. The base station antenna according to claim 17, wherein the first predetermined frequency band is related to a spacing between adjacent first pattern units, a thickness of the first dielectric layer, a dielectric constant of a first dielectric material of the first dielectric layer, and a size of each first pattern unit.

22. The base station antenna according to claim 17, wherein the second predetermined frequency band is related to a spacing between adjacent second pattern units, a thickness of the second dielectric layer, a dielectric constant of a second dielectric material of the second dielectric layer, and a size of each second pattern unit.

23. The base station antenna of claim 20, wherein the first predetermined frequency band is related to a size of the first conductive through holes, and the second predetermined frequency band is related to the size of the second conductive through holes.

24. A base station antenna, comprising:
a radiation element configured to operate in a first frequency band and a second frequency band; and
an absorbing device arranged above the radiation element and configured to absorb electromagnetic waves in the first and second frequency bands,
wherein the absorbing device includes
a dielectric layer formed of a dielectric material and comprising a first surface and a second surface opposite the first surface;
a first pattern layer on the first surface of the dielectric layer, wherein the first pattern layer is formed of a conductive material and includes an array of a plurality of first pattern units of a predetermined shape; and
a second pattern layer on the second surface of the dielectric layer, wherein the second pattern layer is formed of a conductive material and includes an array of a plurality of second pattern units of a predetermined shape.

25. The base station antenna of claim 24, wherein each first pattern unit comprises
a first capacitive structure; and
a first inductive structure in series connection with the first capacitive structure, and the second pattern unit includes a second capacitive structure; and a second inductive structure in series connection with the second capacitive structure.

26. The base station antenna of claim 25, wherein the first capacitive structure and the second capacitive structure are sheet structures, and the first inductive structure and the second inductive structure are line structures.

27. The base station antenna of claim 26, wherein the first inductive structure in each first pattern unit is electrically connected with the inductive structure in an adjacent first pattern unit, and the second inductive structure in each second pattern unit is electrically connected with the inductive structure in an adjacent second pattern unit.

28-34. (canceled)
